(19) United States
(12) Patent Application Publication
(10) Pub. No.: US 2004/0030882 A1
(43) Pub. Date: Feb. 12, 2004

(54) Managed application pre-launching

(76) Inventor: George Henry Forman, Port Orchard, WA (US)

Correspondence Address: HEWLETT-PACKARD COMPANY, Intellectual Property Administration, P.O. Box 272400, Fort Collins, CO, 80527-2400, US

(21) Appl. No.: 10/214,646

(22) Filed: Aug. 8, 2002

(51) Int. Cl. G06F 9/00

(52) U.S. Cl. 713/100

(57) ABSTRACT

An operating system feature for a computing device provides the ability to perform pre-launch subroutines of application programs on the device. A pool of pre-launched application programs is maintained such that a subsequent request for a program launch is married to the already pre-start instances. Provision is also made for monitoring available computing resources, dependencies, and user preferences to optimize device use with respect to launching application programs.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO AN APPENDIX

Not Applicable.

### BACKGROUND OF THE INVENTION

1. Field of the Invention

The present invention relates generally to computer programs.

2. Description of Related Art

Computer hardware generally increases in speed with the release of each new generation of microprocessor integrated circuit used for the central processing unit (CPU). CPU technology is also advancing much faster than integrated circuit memory and memory disk technologies. Software continually gets more complex. Thus, programs are providing greater functionality and versatility and running faster in general, but are taking longer to start, also known as the “launch.” Productivity is halted while the user waits for each program to launch or for a response to certain commands, during which time the hard drive often is extremely active. During this time, the disk access speed is often the bottleneck. A mouse-pointer icon becoming an inactive timepiece—e.g., the Windows™ hourglass, or a “Please wait while the program is loading” splash-screen, pop-up window—which halts all user operations, is a well known frustration for computer users.

Application software structures are trending toward more configurable and interoperable programming techniques. This means even further processing time at start-up for the programs to discover, link, and exchange information with other pieces of active software, such as shared dynamically linked libraries (DLL) and plug-in components. Functions that once were built into a program are separated out into other components that may be separately used and upgraded. This is more flexible but at a cost, especially during start-up time.

There is a state-of-the-art technology to re-order code into a statically linked executable format. When such functions are statically linked, sophisticated compiler technology can in-line or partially evaluate such functions at compile time; this makes the program run faster without start-up time overhead but at the cost of longer compiling times. However, this is contrary to the increasing call for interoperability because dynamic linking must be done with the operating system at start-up; shared DLL files are naturally spread around disk blocks.

A related technology is caching. A small, relatively expensive, but very fast memory is provided as part of the CPU. Most recently accessed memory bits are stored for rapid access in the cache. However, because of cost, caches are relatively small and only help after they have been loaded with the small amount of code that gets exercised in the inner loop of the program. Cache memory does not aid with application program start-up time. In fact, because of the inherent complexity, cache memory use may slightly hurt performance on code that is only exercised once, as is the case with start-up routines.

Another solution has been used in some UNIX™ programs. A programmer can compile-in the start-up phase. After the start-up portion of the code, a halt instruction causes a core dump. The core dump can be converted with the use of a software tool into an executable program containing the complete memory image. Upon execution, continued after the halt instruction, the computer continues processing from where it stopped. The programmer has to be careful that any computation that is particular to the user's task or environment is left until after the halt instruction. This technique is a trade-off of increased executable size for decreased start-up time, especially where much of the start-up time is dominated by computation and setting up of data structures. The increasing componentization of software is again contrary to this technique. Moreover, this solution does not re-open file descriptors, so any file work must be done after the halt instruction.

Another solution is to allow the user to specify that certain applications are to be launched upon the individual logging-on to their computer. For example, the user can list such application in a “Startup” menu of a Windows™ operating system. Later, when the user wants to use an application so designated, it is already started. This makes initial log-on slower since the computer is given a large initial processing task. Moreover, it clutters the user's screen space with icons and the like.

Another solution is to pre-program individual applications to automatically run pre-start routines upon boot-up, where it is assumed by the originating programmer that the product will be used frequently. Then, when the user launches the program, control is passed to the already running process routines. In addition to requiring an assumption that is quite general, namely, that this particular application is used often and universally, this solution requires careful and extraneous programming routines in the application, making it more expensive.

### BRIEF SUMMARY OF THE INVENTION

The present invention is related to computers and application program pre-launch.

The foregoing summary is not intended to be an inclusive list of all the aspects, objects, advantages and features of the present invention nor should any limitation on the scope of the invention be implied therefrom. This Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIG. 1 is a diagram illustrating system components.

FIG. 2 is a flow chart of an exemplary embodiment of the present invention.

Like reference designations represent like features throughout the drawings. The drawings referred to in this specification should be understood as not being drawn to scale except if specifically annotated.

### DETAILED DESCRIPTION OF THE INVENTION

An operating system feature is provided that manages the pre-starting, or pre-launching, of application programs, referred herein as application program “pre-start process instances.” In other words, placing individual application programs into a pre-started state. At times when the computer is otherwise idle or has sufficient excess capacity to launch additional applications, the operating system manages such application program pre-start process instances. At a time later, when the user selects—e.g., mouse “clicks” an icon to launch one of these programs for actual use, the operating system uses the pre-start process instances.

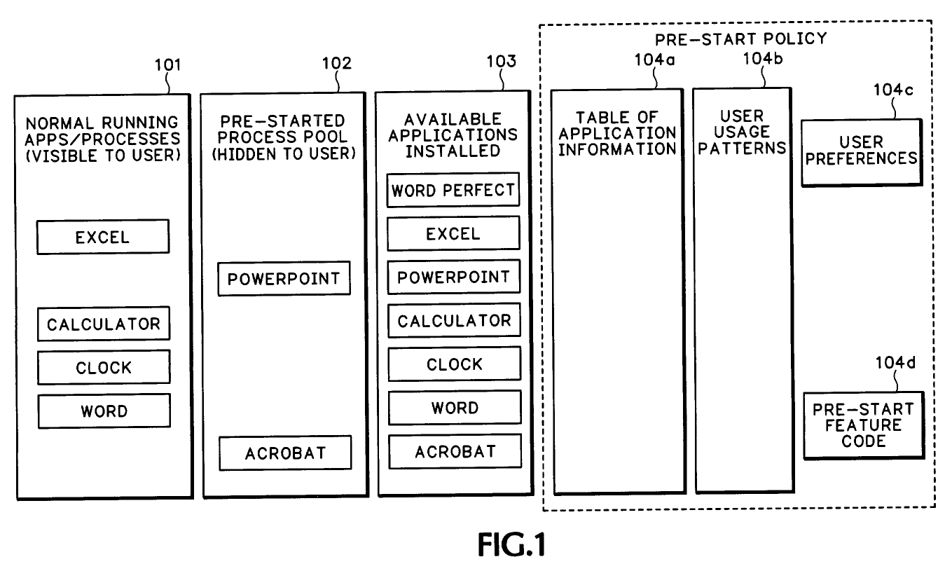

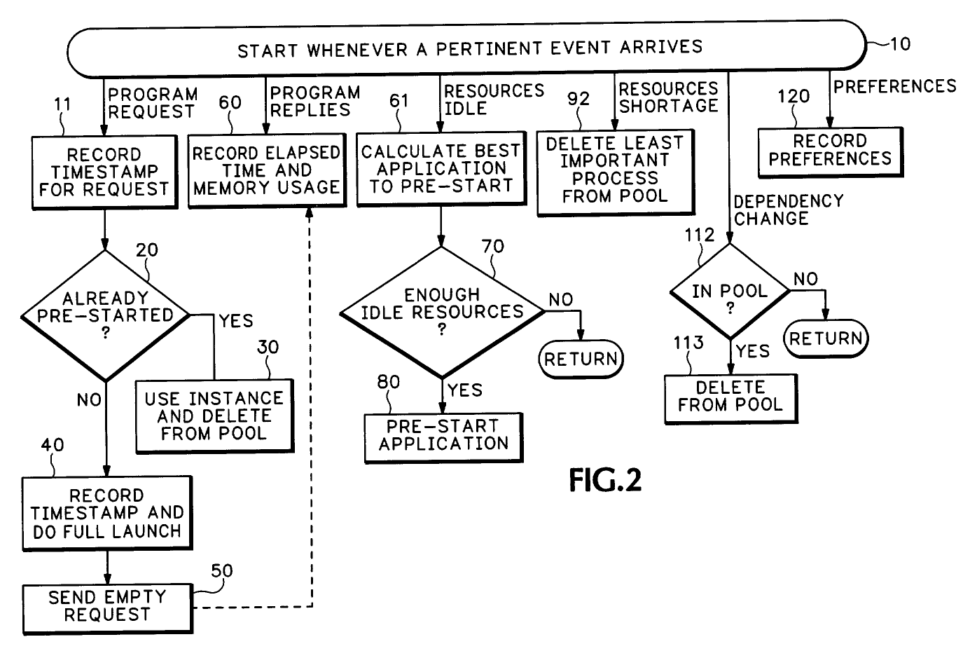

FIG. 1 is a diagram illustrating the system components. The known manner system storage 103 includes installed and available applications, e.g., WordPerfect™, Excel™, PowerPoint™, a calculator, a clock, Word™, and Acroba™. As illustrated by system block 101, during an exemplary, normal, operation the system may be running and have visible to the user Excel, a couple of calculators, a clock and Word. Next, as illustrated by system block 102, in accordance, with this embodiment of the present invention, and as detailed in FIG. 2, a pool of pre-start process instances which are hidden from the user is created. In this example, pre-start process instances are shown for the PowerPoint and Acrobat applications. As illustrated by system blocks 104, which includes sub-blocks 104a, 104b, 104c, and 104d, a pre-start strategy or policy is developed. This may be automated, under user control, or both. Each available application installed in the system storage 103 is registered in a “Table of Application Information” 104a. Statistics are maintained dynamically of user actual application usage patterns 104b. Provision is made for implementing user preferences 104c. Further detail is described for these features by looking simultaneously to FIG. 2.

FIG. 2 is a flow chart illustrating operation of the system according to an embodiment of the present invention, demonstrated in an event model.

Whenever an application launch request occurs—indicated as an arrow path leading from element 10 to element 11 and labeled “start a program”—the request is recorded in a history log, namely “usage patterns” 104b, with a date-time stamp 11 for the purpose of tracking how often the application is used. A decision 20 is made whether the requested application program is already pre-started, that is, as described below, whether the application to be now fully launched already has a pre-started process instance in the pool 102. If so, 20, YES-path, that process instance is used 30; in other words, the requested application becomes visible and available for the user, the process instance being transferred from the pre-started pool to the set of running application processes 101. If there is no pre-start process instance in the pool 102, following element 20, NO-path, the full application launch routine is initiated 40.

To determine the elapsed start-up time required to launch the full application from scratch—and for the benefit of selecting an intelligent pre-start strategy, described hereinafter—an empty request, that is one requiring insignificant computation to formulate only a trivial response to the request, is sent 50 by the operating system to the application-of-interest, e.g., in FIG. 1, WordPerfect which is merely in the available bank 103. When the application completes its start-up phase and is ready to respond to input events, it replies to the empty request and the operating system will receive the associated reply message, also known as the event 10 shown as a “program replies” path. The system will then record 60 the elapsed response time for starting that application and ancillary resource usage data, such as the amount of virtual memory consumed, cumulative disk utilization invested in starting-up the application, and the like. This recorded information may be used to optimize the policy 104 of when to pre-start programs, see element 61, discussed hereinbelow.

The operating system watches for resource idleness—see 10, “resources idle”-path. Whenever resources are idle, a determination 61 is made as to the “most useful” application to add to the prioritized pool 102. In other words, usefulness, or popularity of use, may be relative to the data used for the pre-start strategy based on the current prioritized pool 102 and the knowledge gained from prior use 11, 40, 50, 60, 104b.

A check is then made 70 whether it is worthwhile to pre-start another process instance. If not, 70, NO-path, the process loops back to the next event initiation 10. If so, 70, YES-path, the application is pre-started 80. Any indication that pre-launching of an application is being run preferably is hidden from the user, processed as each idle moment allows until the complete pre-start process instance can be added to the pool. For example, normal Windows™ wait-type splash screens, timer icons, and the like provided by the application programmer while an application is fully launching are simply not displayed. When ready, an indicator of the adding of the pre-start process instance to the current pool for each application may be provided; e.g., by adding an icon to a task bar or the like. Moreover, a pre-start over-ride can be provided by having a small, non-interfering, indicator that a particular program process instance is being added to the pool during idle time, where selecting the indicator will stop that pre-start process instance from taking resources away from the applications the user is currently interested in.

Regarding element 61, “calculate best application to pre-start,” the operating system may randomly select an application to pre-start. However, it is preferred that a more intelligent policy is used, one that depends on the properties of the applications from the table of application information 104a, the application usage patterns 104b of the user, the pre-selected preferences of the user 104c, and the program code for selecting policies 104d, which may be replaceable and upgradeable according to the user's wishes.

Properties of the application, “Table of Application Information” 104a, comprise its installed location on the disk 103, its elapsed time necessary to launch it (see, elements 40, 50, 60), its virtual memory or other resource consumption (see also, element 60).

The usage patterns 104b of the user for each particular application comprise how often they launch it—determined for example from the launch history gathered (see element 11)—what times of the day/week they most often request launching the application, and how many instances of the application they run simultaneously—e.g. a user may never run more than a single instance of Word at a time, but runs plural instances of the calculator simultaneously, as determined by, for example, taking a maximum over the last two months of usage data 104b. Or, e.g., if the user typically launches a data plotting program when working with spreadsheet files in a particular directory, that plotting program may be profitably pre-started.

The preferences 104c may comprise detailed instructions about which processes to pre-start and when, e.g., the user may pre-start an e-mail client at the first idle moment after 4:45 p.m. each weekday because the user habitually retrieves electronic mail at 5:00 p.m. Another option might be to describe a specific resource preference; e.g., the user may prefer to pre-start particular applications installed 103 if at least one-quarter of virtual memory is unused and the screen saver is activated.

As an exemplary program code 104d for selecting which program to pre-start 61, allow that the resources are not considered idle in the first place unless the user's preferences are met for pre-starting another application; e.g., testing the remaining amount of virtual memory and whether the screen saver is active, and only if these conditions are met would a “resources idle” (see labeled arrow of FIG. 2) event be triggered. An aspect of the policy may rule out pre-starting any applications that are already running 101, or if multiple instances of the application are sometimes used, if the maximum number of instances are already running that the user typically uses, e.g., over the last two months. Of the remaining applications, the policy estimates the application probability, PA, that each application will be called for next. For example, if, as determined from recent history logs gathered 11, an application “X” is typically launched ten times per day, and application “Y” is typically launched five times per day, then the next application called for will likely be “X” with a probability

Px=10/total=⅔,

and the next application called for will likely be “Y” with a probability

Py=5/total=⅓.

The probability P_{A} is multiplied by the average time it takes each application to launch (see 40, 50, 60). This result is an estimate of the expected time saving the user will experience for a pre-started application 102. Finally, the policy will select the application with the maximum expected time savings as the next application to add to the pool of pre-start process instances 102. If the application requires more resources (see 60) than are allotted for pre-starting by the user preferences 104c, then that application will be rejected. Optionally, an alternate application may be selected from the remaining list that maximizes the expected savings yet fits within the allotted resource budget. Also, the policy 104 can provide a user-adjustable parameter for a default pre-start blocker, e.g., never pre-starting an application with an expected savings of less than one second.

Note that in estimating whether it is worthwhile to initiate another process instance 70, the operating system may take into consideration other factors than use frequency and actual start-up time required by monitoring and processing user preferences 120. For example, a user may be known 11 to launch an application, e.g. Eudoratm, to retrieve e-mail messages everyday at 5:00 p.m. At 4:45 p.m. every day, the operating policy 104 may automatically begin looking for idle time to initiate a pre-started process instance for Eudora. Note that user-settings can be provided to allow personalization of the computing device, or default over-rides, in order to limit the resources dedicated to the pre-start process instance allocations.

The policy 104 may also monitor whether resources are becoming dangerously low; see arrow labeled “resource shortage.” For example, when virtual memory is nearly exhausted, most operating systems notify the user, suggesting that the user close some applications. If resources are deemed too low, the pool of pre-started process instances is assessed and a random process or the “least important” process instance is deleted 92. This freeing-up 92 of resource allocation is repeated until sufficient resources are again available.

Note that application program interoperability with the operating system can be tailored. For example, applications can be written so that their dependence on program inputs that are specific to the user's launch request e.g., the filename to open by the application—occurs as late as possible in the start-up sequence, so that most start-up overhead can be hidden in the pre-start phase. That is, the operating system is in control of start-up pre-started process instances and appropriately implements generic start-up to the point when the application needs to call to the operating system to get specific arguments for a specific invocation as may have been designated by the user for the current launch with that specific set of parameters. At the point of that request, further processing of that application program is delayed until the user makes a launch request later and their arguments can then be give to the application.

The operating system also monitors for dependency changes—see labeled arrow. For example, a new version of an application may be downloaded. If a dependency change is made, and there is an active start-up process instance in the pool, 112, YES-path, the operating system removes the affected process instance from the pool 113. The operating system may later choose to restart that application with its new code installation or other dependency change.

Thus, an operating system for a computing device provides the ability to perform pre-launch of application programs 103 on the device. A pool 102 of pre-launched application programs is maintained such that a subsequent request for a program launch is married to the already pre-start process instances. Provision is also made for monitoring available computing resources, dependencies, and user preferences to optimize device use with respect to launching application programs.

The foregoing description of exemplary and preferred embodiments has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable or combinable with other steps in order to achieve the same result. Each embodiment was chosen and described in order to best explain the principles of the invention and its best mode practical application, thereby to enable others skilled in the art to understand the invention for various embodiments and with various modifications as are suited to the particular use or implementation contemplated. While this disclosure is made with respect to the current state-of-the-art, it must also be recognized that there may be advancements to the state-of-the-art; therefore, future adaptations may take into consideration and apply such advancements. Therefore, no limitation on the scope of the invention as claimed is intended by the foregoing description which may have included tolerances, feature dimensions, specific operating conditions, engineering specifications, and the like, which may vary between implementations and adaptations or with changes to the state-of-the-art by the time of implementation, and none should be implied therefrom. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . .” What is claimed is:

1. An operating system, having a processing unit and programs, the system comprising:
an operating system mechanism for selecting, when the processing unit is otherwise idle, at least one of said programs for putting said at least one of said programs into a pre-launch condition using at least some of said at least one of said programs intrinsic full launching routines.

2. The system as set forth in claim 1 wherein said pre-launch condition includes implementing pre-start process instances for each selected one of said programs and pooling said pre-start process instances for subsequent user selection from pooled pre-start process instances such that full launch time of a selected instance is reduced.

3. The system as set forth in claim 2 wherein the operating system further includes an operating system process for monitoring resources for maintaining said at least one of said programs in said pre-launch condition until a full launch request or one of said pooled pre-start process instances is removed due to lack of said resources.

4. The system as set forth in claim 2 wherein the operating system further includes an operating system process for combining at least one of the pooled pre-start process instances with data associated with said full launch when said program is selected for said full launch.

5. The system as set forth in claim 1 wherein is included an operating system process for selectively ordering said plurality of programs loaded in said device according to a predetermined strategy.

6. The system as set forth in claim 5 wherein said ordering is associated with elapsed time for launching a respective one of said programs.

7. The system as set forth in claim 5 wherein said ordering is associated with frequency of use of a respective one of said programs.

8. The system as set forth in claim 1 wherein is included an operating system process for monitoring and for implementing preferences associated with each of said programs respectively.

9. The system as set forth in claim 1 wherein is included an operating system process for monitoring and for implementing program dependencies for each of said programs respectively and for removing associated pre-started process instances for a program affected by said process for monitoring and for implementing program dependencies.

10. The system as set forth in claim 2 comprising:
following putting at least one program of said programs into a pre-launched condition, included is an operating system process for determining value in pre-launching additional respective ones of said programs.

11. A computer operating system for an apparatus having a plurality of application programs, the system comprising:
means for collecting base data information regarding said programs relating to requirements for pre-starting each of said programs; and
means for creating a pool of pre-started application programs implemented in accordance with said base data information such that full launch of individual ones of said application programs is from said pool.

12. The system as set forth in claim 11 further comprising:
means for prioritizing which of said programs to add to said pool whenever said operating system has sufficient idle resources.

13. A method for operating a computing device having a plurality of available programs, the method comprising:
waiting for processor idle time; and
during said idle time, selecting one of said available programs, running pre-launch processes for said one, placing the one into a pre-launched program condition, and storing the pre-launched program condition into a pool of available pre-launched programs.

14. The method as set forth in claim 13, the selecting further comprising:
having a predetermined strategy for selecting which of the available programs is the one of said available programs currently selected for said running pre-launch processes.

15. The method as set forth in claim 13 wherein said running available program pre-launch processes is transparent to currently active said programs of the computing device.

16. The method as set forth in claim 14 comprising:
upon a program start request for a program, determining if said request is associated with a pre-launched program condition in said pool.

17. The method as set forth in claim 16 comprising:
recording a date and time stamp of said start request, and
using said date and time stamp for modifying said pre-launch strategy.

18. The method as set forth in claim 16 wherein when said start request is associated with a pre-launched program condition in said pool, using said pre-launched program condition to start said related program and deleting said pre-launched program condition from said pool.

19. The method as set forth in claim 16 wherein when said start request is not associated with a pre-launched program condition in said queue, launching the related program and monitoring elapsed time to launch said related program, and
using said elapsed time for modifying said pre-launch strategy.

20. The method as set forth in claim 14 further comprising:
a pre-launch strategy analysis including using a frequency of use factor for each said available program.

21. The method as set forth in claim 20 wherein said pre-launch strategy analysis includes combining said elapsed time with said frequency of use factor and ordering said pool into a queue based on said combining.

22. The method as set forth in claim 14 comprising:
monitoring computing device preferences.

23. The method as set forth in claim 22, further comprising:
re-combining said preferences with the combining of said elapsed time with said frequency of use factor and re-ordering said queue based on said recombining.

24. The method as set forth in claim 13 comprising:
monitoring computing resources available for currently active user programs of said device, and
when said computing resources become low so as to affect computing power of the device, selectively removing each pre-launched program instances from said pool of available pre-launched programs.

25. The method as set forth in claim 13 comprising:
monitoring for changes to user programs of said device, and
when a change for one of said programs is detected, determining if a pre-launched program instance is in said pool and if so, removing said instance from said pool.

26. The method as set forth in claim 14, said strategy further comprising:
making selected ones of said programs respectively ineligible for said running.

27. A computer memory comprising:
program code for pre-starting application programs into a pre-started state; and
program code for launching applications programs using said pre-started state.

28. The memory as set forth in claim 27 further comprising:
program code for strategizing which application programs are appropriate to be processed by said code for pre-starting application programs.

29. A computing device comprising:
application programs; and
an operating system for controlling said application programs, the operating system including
placing one or more of said programs into a respective state of readiness wherein all respective pre-launching processes of said programs, other than those, if any, requiring start-up parameters and actual launch commands, are processed and stored such that actual launching of one of said one or more said programs on-demand requires only said start-up parameters or data and actual launch commands.

30. An operating system comprising:
a pre-start strategy process wherein each available application installed in the system memory is registered in a data base of application information wherein statistics are maintained dynamically of user actual application usage patterns; and
pre-start process instances implementing user preferences relate to each available application wherein, from the available applications themselves, features for the pre-start process instances are extracted for use in accordance with the pre-start strategy.
